(19) United States
(12) Patent Application Publication
(10) Pub. No.: US 2012/0178332 A1
(43) Pub. Date: Jul. 12, 2012

(54) Fiber Comprising Heat Curable Polyamide Resin Composition, Nonwoven Fabric And Producing Method Thereof

(75) Inventors: Makoto Uchida, Kita-ku (JP); Yasumasa Akatsuka, Kita-ku (JP); Kazunori Ishikawa, Kita-ku (JP); Shigeru Moteki, Kita-ku (JP)

(73) Assignee: NIPPON KAYAKU KABUSHIKI KAISHA, Chiyoda-ku, Tokyo (JP)

(21) Appl. No.: 13/395,972

(22) PCT Filed: Oct. 22, 2010
(86) PCT No.: PCT/JP2010/006277

§ 371 Date: Mar. 14, 2012

(30) Foreign Application Priority Data
Oct. 29, 2009 (JP) 2009-249243

(51) Int. Cl. D04H 1/728; C08L 77/00; D02G 3/02; B29C 47/00; B82Y 30/00

(52) U.S. Cl. 442/351; 428/401; 264/465; 525/418; 977/762

(57) ABSTRACT

The present invention relates to a fiber comprising a heat curable polyamide resin composition containing both a) a phenolic hydroxy group-containing polyamide and b) an epoxy resin having two or more epoxy groups in one molecule, a nanofiber comprising said resin composition obtained by electrospinning method, a nonwoven fabric obtained by applying heat treatment to a laminate of said nanofiber, a method for producing said nanofiber by electrospinning method and a heat curable polyamide resin composition for fiber. A nonwoven fabric can be obtained only by subjecting a deposit of the nanofiber obtained by electrospinning method to heat treatment, nanofibers in the obtained nonwoven fabric are bonded to each other by heat-curing, and the nonwoven fabric has such characteristics that its mechanical strength, heat resistance and chemical resistance are excellent and that it has a high strength.

### TECHNICAL FIELD

The present invention relates to a heat curable composition for fiber containing a phenolic hydroxy group-containing polyamide resin and an epoxy resin, a nanofiber comprising said composition, a nonwoven fabric where a deposit of said nanofiber is heat-cured, and a method of producing them.

### BACKGROUND ART

Conventionally, various organic fibers are used for nonwoven fabrics used for filter materials and cushioning materials. In particular, a nonwoven fabric constituting a filter for engines of spacecrafts, aircrafts and the like, a bag filter for dust collection equipments such as industrial incinerators, and the like, a nonwoven fabric used in separators for fuel cells and separators for electronic parts such as electrode, and a nonwoven fabric used for cushioning materials in manufacturing process in the fields of steel, ceramics and non-ferrous metal need heat resistance, chemical resistance and mechanical strength, so inorganic nonwoven fabrics comprising a glass fiber or a fiber of metal and metal oxide and organic nonwoven fabrics comprising a polyphenylene sulfide fiber, an aramid fiber, a polyimide fiber or a fluorine fiber have been used.

However, fibers are not bonded to each other in the inorganic nonwoven fabrics, so inorganic fiber dust generated when manufacturing, using and disposing the nonwoven fabrics has adverse effects on human bodies and the environment, leading to avoidance of their use. In addition, they are not suitable for cushioning materials due to their high elastic modulus. Further, it has been difficult to be used for application of electronic parts because they contain impurity ions. Furthermore, the organic nonwoven fabrics have had such problematic points that their heat resistance is generally insufficient, they have been difficult to be manufactured as a textile, their durability against organic solvents is insufficient because they have no bond between fibers, and that their mechanical strength is insufficient.

In order to improve heat resistance, durability against organic solvents and mechanical strength, a thermal bonding method (Patent Literature 1) where fibers having a low melting point are melted by heat to bond fibers, a chemical bonding method (Patent Literature 2) where fibers of a nonwoven fabric which impregnated or whose surface is sprayed with an adhesive are adhered by heat, and the like have been invented as a fleece bonding method of bonding between fibers. However, the nonwoven fabric of Patent Literature 1 contains a low melting point compound or a thermoplastic resin and therefore is deformed or melted under a high temperature, and thus its heat resistance is insufficient. On the other hand, the nonwoven fabric of Patent Literature 2 employs an adhesive for bonding the fibers and therefore the certain component or the resin are dissolved in an organic solvent, and thus its chemical resistance and mechanical strength are insufficient.

In addition, Patent Literature 3 discloses a heat curable polyamide resin composition containing a phenolic hydroxy group-containing polyamide resin and an epoxy resin as an adhesive composition.

### RELATED TECHNICAL LITERATURE

### Patent Literatures

Patent Literature 1: Japanese Patent Laid-Open No. H9-176948, Publication.
Patent Literature 2: Japanese Patent Laid-Open No. 2007-217844, Publication.
Patent Literature 3: Japanese Patent Laid-Open No. 2005-29710, Publication.

### SUMMARY OF THE INVENTION

### Problems to be Solved by the Invention

It is an object of the present invention to provide a nanofiber comprising a heat curable resin composition and a nonwoven fabric excellent in heat resistance, chemical resistance and mechanical strength, which is obtained from said nanofiber.

### Means of Solving the Problems

The present inventors have been intensively studied to solve the above-described problems and found that the above-described problems can be solved by a nonwoven fabric obtained by producing nanofibers having heat curability per se using a heat curable resin composition and by bonding said nanofibers by heat curing, and the present invention has been completed. That is, the present invention relates to the below-described (1) to (16):

(1) A heat curable fiber comprising a heat curable polyamide resin composition containing a) a phenolic hydroxy group-containing polyamide resin and b) an epoxy resin having two or more epoxy groups in one molecule.
(2) The heat curable fiber according to the above-described (1), wherein a) the phenolic hydroxy group-containing polyamide resin is a random copolymer aromatic polyamide resin having a repeating structure represented by the following formula (A):

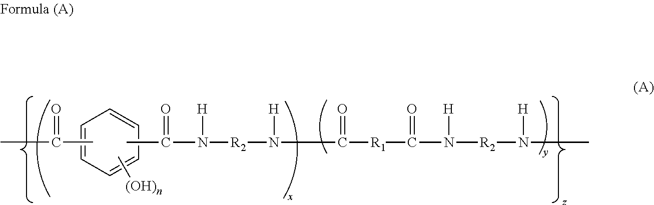

wherein R₁ and R₂ each represents a divalent aromatic group and may be the same or different from each other; n is an average number of substituents and represents a positive number of 1 to 4; and x, y and z are each an average degree of polymerization, x represents a positive number of 1 to 10, y represents a positive number of 0 to 20 and z represents a positive number of 1 to 50, respectively.
(3) The heat curable fiber according to the above-described (1) or (2), which is a nanofiber having a fiber diameter of 10 to 1000 nm.
(4) The heat curable fiber according to the above-described (3), which is produced by electrospinning method.
(5) A nonwoven fabric, wherein a deposit of the heat curable fiber according to the above-described (3) is heat-cured.
(6) A heat resistant bag filter, wherein the nonwoven fabric according to the above-described (5) is used.
(7) A secondary battery separator, wherein the nonwoven fabric according to the above-described (5) is used.
(8) A secondary battery electrode, wherein the nonwoven fabric according to the above-described (5) is used.
(9) A heat insulating material, wherein the nonwoven fabric according to the above-described (5) is used.
(10) A filter cloth, wherein the nonwoven fabric according to the above-described (5) is used.
(11) A sound absorbing material, wherein the nonwoven fabric according to the above-described (5) is used.
(12) A method for producing a heat curable fiber, characterized in that while applying a voltage between a spinning nozzle of a container for electrospinning and a collector; a spinning solution is spun from the spinning nozzle; and thus obtained nanofiber according to the above-described (3) is collected on the collector; the container is filled with a solution including a heat curable polyamide resin composition containing a) a phenolic hydroxy group-containing polyamide resin and b) an epoxy resin having two or more epoxy groups in one molecule.
(13) A method for manufacturing a nonwoven fabric with nanofibers fixed to each other, wherein a deposit of the nanofiber according to the above-described (3) is obtained by electrospinning and the deposit is heat-cured.
(14) Use of a heat curable polyamide resin composition containing a) a phenolic hydroxy group-containing polyamide resin and b) an epoxy resin having two or more epoxy groups in one molecule, for producing a fiber.
(15) A heat curable polyamide resin composition for fiber, which contains a) a phenolic hydroxy group-containing polyamide resin and b) an epoxy resin having two or more epoxy groups in one molecule.
(16) The heat curable polyamide resin composition for fiber according to the above-described (15), wherein the a) phenolic hydroxy group-containing polyamide resin is a random copolymer aromatic polyamide resin having a repeating structure represented by the following formula (A):

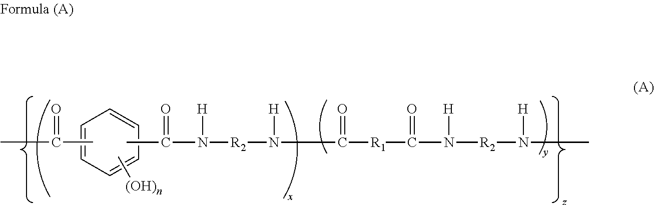

wherein, R₁ and R₂ each represents a divalent aromatic group and may be the same or different from each other; n is an average number of substituents and represents a positive number of 1 to 4; and x, y and z are each an average degree of polymerization, x represents a positive number of 1 to 10, y represents a positive number of 0 to 20 and z represents a positive number of 1 to 50, respectively.

### Effect of the Invention

The heat curable polyamide resin composition for fiber of the present invention can be made into a fiber by dissolving in a solvent and by spinning, and the fiber comprising said resin composition can be produced by electrospinning method. And, the fiber can be made into a nonwoven fabric by applying heat treatment to its deposit. In particular, when producing a nanofiber by electrospinning method, the nanofiber can be obtained as a deposit, and the obtained deposit can be made into a nonwoven fabric only by heat treatment. The nanofibers in said nonwoven fabric are directly bonded and cured at contact parts, so said nonwoven fabric has characteristics that its chemical resistance and mechanical strength are more excellent than those of conventional nonwoven fabrics. Therefore, said nonwoven fabric can be utilized for heat resistant bag filters, secondary battery separators, heat insulating materials, various filters, sound absorbing materials, and the like.

### BRIEF DESCRIPTION OF THE DRAWINGS

FIG. 1 shows an electron microscope photograph of a nanofiber obtained by electrospinning method in Example 1.

FIG. 2 shows an electron microscope photograph of a nanofiber obtained by electrospinning method in Example 2.

FIG. 3 shows an electron microscope photograph of a nanofiber obtained by electrospinning method in Example 3.

FIG. 4 shows an electron microscope photograph of a nanofiber obtained by electrospinning method in Example 4.

FIG. 5 shows an electron microscope photograph of a nonwoven fabric obtained in Example 5.

### MODE FOR CARRYING OUT THE INVENTION

The heat curable polyamide resin composition for fiber of the present invention contains a) a phenolic hydroxy group-containing polyamide resin and b) an epoxy resin having two or more epoxy groups in one molecule. As a) the phenolic hydroxy group-containing polyamide resin, any polyamide resin can be used as long as it has a phenolic hydroxy group in its molecule structure. Preferably, said resin can include a phenolic hydroxy group-containing polyamide having a segment represented by the following formula (1):

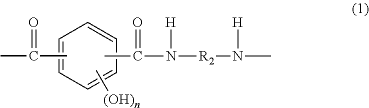

(wherein, R₂ represents a divalent aromatic group, n is an average number of substituents and represents a positive number of 1 to 4).

The —R₂— group in the segment of the formula (1) represents at least one kind among the aromatic residues represented by the following formula (2):

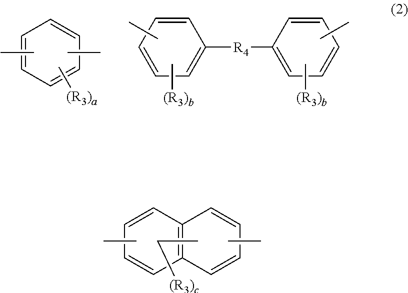

(wherein, R₃ represents a hydrogen atom or a substituent having 0 to 6 carbon atoms which may contain O, S, P, F, Si; R₄ represents a direct bond or a bond constituted by 0 to 6 carbon atoms which may contain O, S, P, F, Si; and a, b and c are each an average number of substituents, a represents a positive number of 0 to 4, b each independently represents a positive number of 0 to 4, and c represents a positive number of 0 to 6), and R₄ in a plurality of segments present in the polyamide may be the same or different. Among them, the aromatic residue represented by the following formula (3) is particularly preferable.

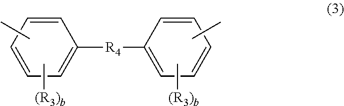

(Wherein, R₃, R₄ and b have the same meanings as in formula (2).)

Preferable R₃ in the above-described formulas (2) or (3) includes a hydrogen atom; a hydroxy group; a C1 to C6 chain alkyl group such as a methyl group, an ethyl group, a propyl group, a butyl group, a pentyl group and a hexyl group; a C4 to C6 cyclic alkyl group such as a cyclobutyl group, a cyclopentyl group and a cyclohexyl group; and the like, and R₃ may be the same or different from each other. It is usually preferred that all of R₃ are the same. Preferable R₄ in the above-described formulas (2) or (3) includes a direct bond, —O—, —SO₂—, —NH—, —(CH₂)₁₋₆— and the like and it is more preferably —O— or —CH₂—. In this regard, the bonding positions for the bonds on the two aromatic rings are preferably 4,4′. That is, the diamine component used for synthesis of polyamide is preferably a diamine diphenyl compound having amino groups at 4,4′. A more preferable group of the formula (3) can include a group where R₃ is a hydrogen atom (when b is 0), R₄ is —O— or —CH₂—, and the bonding positions of the two aromatic rings are 4,4′.

In addition, a) the phenolic hydroxy group-containing polyamide resin in the present invention may have segments all of which have the structure of the above formula (1), or segments having different structures. Usually, the latter is preferable. Said polyamide resin is preferably a resin having a repeating structure represented by the above formula (A), and it is more preferable that all the segments are the above formula (A). In this case, the divalent aromatic group represented by —R₁— in the formula (A) is preferably any one kind of the aromatic residues represented by the above formula (2). R₁ in a plurality of segments may be the same or different and usually the same. —R₁— is preferably the aromatic residue represented by the following formula (4):

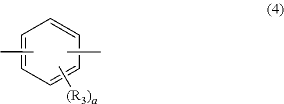

(wherein, R₃ and a have the same meanings as in formula (2)).

Preferable R₃ in the formula (4) is the same as in the above formula (3) and more preferably a hydrogen atom. The two bonding positions in the formula (4) may be any, and when one bonding position is the 1-position, the other bonding position is preferably the 3-position (meta-position) on the aromatic ring (benzene ring).

The phenolic hydroxy group-containing polyamide resin a) in the heat curable polyamide resin composition for fiber of the present invention can be usually obtained by reaction of a phenolic hydroxy group-containing aromatic dicarboxylic acid and optionally another dicarboxylic acid (preferably, aromatic dicarboxylic acid) with aromatic diamine, using a condensation agent.

Specific examples of the phenolic hydroxy group-containing aromatic dicarboxylic acid which can be used for the condensation reaction includes hydroxyisophthalic acid, dihydroxyisophthalic acid, hydroxyterephthalic acid, dihydroxyterephthalic acid, hydroxyphthalic acid, dihydroxyphthalic acid and the like. Among them, 5-hydroxyisophthalic acid, 4-hydroxyisophthalic acid, 2-hydroxyisophthalic acid, 4,6-dihydroxyisophthalic acid, 2-hydroxyterephthalic acid, 2,5-dihydroxyterephthalic acid and 4-hydroxyphthalic acid are preferable, and 5-hydroxyisophthalic acid is more preferable.

The aromatic diamine which can be used for the condensation reaction includes diaminobenzene compounds or diaminonaphthalene compounds such as phenylenediamine, diaminotoluene, diaminoxylene, diaminomesitylene, diaminodurene, diaminoazobenzene and diaminonaphthalene; diaminobiphenyl compounds such as diaminobiphenyl and diaminodimethoxybiphenyl; diaminodiphenyl ether compounds such as diaminodiphenyl ether and diaminodimethyldiphenyl ether; diaminodiphenylmethane compounds such as methylene dianiline, methylene bis(methylaniline), methylene bis(dimethylaniline), methylene bis(methoxyaniline), methylene bis(dimethoxyaniline), methylene bis(ethylaniline), methylene bis(diethylaniline), methylene bis(ethoxyaniline), methylene bis(diethoxyaniline), isopropylidene dianiline and hexafluoroisopropylidene dianiline; diaminobenzophenone compounds such as diaminobenzophenone and diaminodimethylbenzophenone; diamino anthraquinone, diaminodiphenyl thioether, diaminodimethyldiphenyl thioether, diaminodiphenylsulfone, diaminodiphenyl sulfoxide, diamino fluorene and the like. Among them, diaminodiphenyl ether compounds or diaminodiphenylmethane compounds are preferable, and diaminodiphenyl ether or methylene dianiline is particularly preferable.

Specific examples of other aromatic dicarboxylic acids which can be used in combination with the phenolic hydroxy group-containing aromatic dicarboxylic acid include isophthalic acid, terephthalic acid, biphenyldicarboxylic acid, oxydibenzoic acid, thiodibenzoic acid, dithiodibenzoic acid, carbonyldibenzoic acid, sulfonyldibenzoic acid, naphthalenedicarboxylic acid, methylenedibenzoic acid, isopropylidene dibenzoic acid, hexafluoroisopropylidene dibenzoic acid and the like, and among them, isophthalic acid, terephthalic acid, biphenyldicarboxylic acid, oxydibenzoic acid and naphthalenedicarboxylic acid are preferable, and isophthalic acid is more preferable. When these other aromatic dicarboxylic acids are used, it is preferred to use 99% by mol or less, optionally 95% by mol or less and 40% by mol or more and preferably 60% by mol or more in combination, based on the total amount of the dicarboxylic acid component.

Specific examples of the condensation agent to be used include, for example, phosphite ester and tertiary amine. For the condensation reaction, the aromatic diamine component and the dicarboxylic acid component are reacted usually in the presence of such a condensation agent, if necessary, in an inert solvent, and further by addition of phosphite ester and tertiary amine.

Specific examples of the phosphite ester can include triphenyl phosphite, diphenyl phosphite, tri-o-tolyl phosphite, di-o-tolyl phosphite, tri-m-tolyl phosphite, tri-p-tolyl phosphite, di-p-tolyl phosphite, di-p-chlorophenyl phosphite, tri-p-chlorophenyl phosphite, di-p-chlorophenyl phosphite and the like, and two or more kinds thereof can be mixed, but triphenyl phosphite is preferable. The use amount thereof is usually 1.0 to 3.0 mol and preferably 1.5 to 2.5 mol, relative to 1.0 mol of the diamine compound to be used.

The tertiary amine to be used together with the phosphite ester can be exemplified by pyridine compounds such as pyridine, 2-picoline, 3-picoline, 4-picoline and 2,4-lutidine, and the use amount thereof is usually 1.0 to 4.0 mol and preferably 2.0 to 3.0 mol, relative to 1.0 mol of the diamine to be used.

The above reaction is generally carried out in an inert solvent, and it is desired that the inert solvent does not substantively react with the phosphite ester, has a property allowing the above-described diamine and the above-described dicarboxylic acid to be well dissolved, and also is a good solvent for the polyamide resin as a reaction product. Such a solvent includes aprotic polar solvents like N-methyl-2-pyrrolidone, N,N-dimethylacetamide, N,N-dimethylformamide, N-methyl caprolactam, N,N-dimethylimidazolidine, dimethylsulfoxide, tetramethylurea and pyridine, nonpolar solvents such as toluene, hexane and heptane, tetrahydrofuran, diglyme, dioxane, trioxane and the like, or mixed solvents thereof. In particular, pyridine alone, which also serves as the above tertiary amine, or a mixed solvent composed of pyridine and N-methyl-2-pyrrolidone is preferable. The use amount of these solvents is usually 0 to 500 ml and preferably 50 to 300 ml, relative to 0.1 mol of diamine.

In order to obtain a polyamide resin having a large polymerization degree, it is preferred to add the above-described phosphite ester, tertiary amine, an inert solvent and in addition, an inorganic salt such as lithium chloride and calcium chloride. The addition amount thereof is usually 0.1 to 2.0 mol and preferably 0.2 to 1.0 mol, relative to 1.0 mol of a diamine compound to be used.

Hereinafter, the method for producing the polyamide resin used for the heat curable polyamide resin composition for fiber of the present invention will be specifically explained. Firstly, an inorganic salt is, if necessary, added to a solution comprising an organic solvent containing tertiary amine. After that, phenolic hydroxy group-containing aromatic dicarboxylic acid and usually another dicarboxylic acid are further added thereto; 0.5 to 2 mol of aromatic diamine relative to 1 mol of all the dicarboxylic acid components are further added; phosphite ester is subsequently added dropwise while heating and stirring under an inert atmosphere of nitrogen or the like to react. The reaction temperature is usually 30 to 180° C. and preferably 80 to 130° C. The reaction time is usually 30 minutes to 24 hours and preferably 1 to 10 hours.

After completion of the reaction, the reaction mixture is put into a poor solvent such as water or methanol to separate the polymer and then purification is carried out by reprecipitation or the like to remove a by-product and inorganic salts, so that a phenolic hydroxy group-containing polyamide resin to be used in the present invention can be obtained.

The weight average molecular weight of the above-described phenolic hydroxy group-containing polyamide resin is preferably 10,000 to 1,000,000. The log viscosity value (as measured with 0.5 g/dl of N,N-dimethylacetamide solution at 30° C.) of the polyamide resin having such a preferable weight average molecular weight is in the range of 0.1 to 4.0 dl/g.

Judgment on whether having a generally preferable weight average molecular weight or not is carried out by reference to this inherent viscosity. A too low inherent viscosity is not preferable because it leads to inferior fiber formability and insufficient property appearance as a polyamide resin. In contrast, a too high intrinsic viscosity poses such problems that the solvent solubility becomes worse due to the too high molecular weight and that spinning becomes difficult. The easy method of controlling the molecular weight of the polyamide resin can include a method where either the diamine component or the dicarboxylic acid component is excessively used.

In addition, the hydroxy group equivalent of the above-described phenolic hydroxy group-containing polyamide resin to be used in the present invention can be appropriately changed according to the purpose of use and the like, but it is preferably about 5,000 to 50,000 and about 10,000 to 50,000 in light of chemical resistance.

As b) the epoxy resin having two or more epoxy groups in one molecule in the present invention, any epoxy resin can be used as long as it has two or more epoxy groups in its structure. Specifically, it includes alicyclic epoxies such as bis(epoxycyclohexyl)carboxylate; novolak-type epoxy resins; xylylene skeleton-containing phenol novolak-type epoxy resins; biphenyl skeleton-containing novolak-type epoxy resins; bisphenol type epoxy resins such as bisphenol A-type epoxy resin or bisphenol F-type epoxy resin; tetramethylbiphenol-type epoxy resins; and the like. Biphenyl skeleton-containing novolak-type epoxy resins represented by the following formula (5) are preferable.

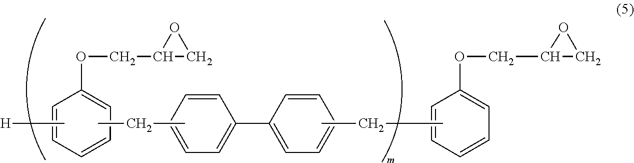

Wherein, m represents an average value and represents a positive number of 0.1 to 10.

These epoxy resins can be available as a commercial product, and specific trade names thereof include NC-3000 and NC-3000-H (which are all manufactured by Nippon Kayaku Co., Ltd.) and the like.

In the present invention, the component a) acts as a curing agent for the component b), as a curing agent in the present invention, however, another curing agent may be used in combination with the component a). Specific examples of the curing agent which can be used in combination include diaminodiphenylmethane, diethylenetriamine, triethylenetetramine, diaminodiphenylsulfone, isophoronediamine, dicyandiamide, polyamide resins synthesized by a dimer of linolenic acid and ethylenediamine, phthalic anhydride, trimellitic anhydride, pyromellitic dianhydride, maleic anhydride, tetrahydrophthalic anhydride, methyltetrahydrophthalic anhydride, nadic methyl anhydride, hexahydrophthalic anhydride, methylhexahydrophthalic anhydride, phenol novolac, triphenylmethane and modified thereof, imidazole, BF₃-amine complexes, guanidine derivatives and the like, but not limited thereto.

The component a) accounts for usually 20% by mass to 100% by mass, preferably about 30% by mass to 98% by mass and more preferably about 50% by mass to 97% by mass in all the curing agents.

For the use amount of the curing agents containing the component a) in the present invention, the total amount of the functional groups in all the curing agents is preferably 0.7 equivalent or more and more preferably 0.7 to 1.2 equivalents relative to 1 equivalent of the epoxy group in the component b). When the total amount of the functional groups in the curing agents is less than 0.7 equivalent relative to 1 equivalent of the epoxy group, it is feared that curing is incomplete and good cured physical properties are not obtained; and when it is over 1.2 equivalents, there is no problem in curing but many of the functional groups in the curing agents remain and the hydrophilic property is higher, leading to fear of increase in the water absorption percentage and decrease in chemical resistance of the obtained nonwoven fabric.

In addition, the heat curable polyamide resin composition for fiber of the present invention may contain a curing accelerator. Specific examples of the curing accelerator which can be used include, for example, imidazoles such as 2-methylimidazole, 2-ethylimidazole and 2-ethyl-4-methylimidazole; tertiary amines such as 2-(dimethyl aminomethyl)phenol and 1,8-diaza-bicyclo(5,4,0)undecene-7; phosphines such as triphenyl phosphine; metal compounds such as tin octylate, and the like. The curing accelerator is, according to necessity, used in an amount of 0.1 to 5.0 parts by mass relative to 100 parts by mass of the epoxy resin component.

To the heat curable polyamide resin composition for fiber of the present invention, various additives can be added in such a range as not to harm the curing properties and not to inhibit the bonding between nanofibers. The additives which can be used include, for example, metal nano particles such as silver, copper and zinc, inorganic nano particles such as titanium oxide, barium titanate, boron nitride and diamond, resins such as polyimide, polytetrafluoroethylene and polybenzoxazole, dyes, antifoggants, antifade reagents, antihalation agents, fluorescent brightening agents, surfactants, leveling agents, plasticizers, flame retarders, antioxidants, antistatic agents, dehydrating agents, reaction retardants, light stabilizers, light catalysts, anti-fungus agents, antibacterial agent, magnetic materials, thermally decomposable compounds and the like.

The fiber diameter of the fiber of the present invention obtained using the heat curable polyamide resin composition for fiber of the present invention is preferably about 10 to 1000 nm. The fiber having a fiber diameter in this range is referred to as a nanofiber in the present invention. The fiber diameter is more preferably about 50 to 1000 nm and further preferably about 100 to 500 nm. The fiber diameter here represents a diameter of the nanofiber which can be visually observed, for example, with an electron microscope photograph. In addition, the aspect ratio of the fiber diameter to the fiber length is preferably larger, usually 20 or more, preferably 25 or more, more preferably 50 or more, further preferably 100 or more and most preferably 1000 or more. When the aspect ratio is too small (specifically, near to that of a particle), it is feared that the mechanical strength of a nonwoven fabric obtained by curing and adhering fibers is reduced.

The aspect ratio of the nanofiber which can be obtained in the present invention is usually about 20 to 500,000 and preferably about 100 to 500,000.

The fiber of the present invention can be easily obtained by electrospinning method, using a solution (also referred to as spinning solution) dissolving the heat curable polyamide resin composition for fiber of the present invention in a solvent.

The electrospinning method used in the present invention can be specifically carried out by putting a spinning solution into a container for electrospinning which has a spinning nozzle and by spinning the charged spinning solution from the spinning nozzle to form an aggregate composed of nanofibers on a collector, in an atmosphere where a strong electric field is formed by applying a large electric potential difference between the spinning nozzle (also referred to as head) for spinning fibers and the above collector for collecting spun fibers.

That is, the heat curable fiber of the present invention can be obtained by applying a voltage between a spinning nozzle of a container for electrospinning with a solution of the heat curable polyamide resin composition used in the present invention and a collector, by spinning the spinning solution from the spinning nozzle, and by collecting nanofibers having a fiber diameter of 10 to 1000 nm on a collector.

In this regard, in the present invention, collecting on a collector includes any case of directly collecting on a collector or of setting a substrate or the like on a collector followed by collecting thereon.

The electrospinning method used in the present invention is specifically mentioned as follows: for example, a resin composition solution is put into a syringe (container for electrospinning) with a metal needle (whose tip is perpendicularly cut) (spindle opening) having an internal diameter of 0.3 to 0.5 mm; a substrate is placed on a metal plate (collector) spacing about 200 mm from the needle tip; and a voltage of 10 to 20 kV is applied between the needle tip and the metal plate to accumulate nanofibers on the substrate in a few hours. Any substrate can be used as long as it does not inhibit formation of a strong electric field. When the nanofiber of the present invention is peeled off the substrate for use, it is preferred to use a substrate to which the nanofiber of the present invention does not adhere, such as aluminum foil or the like.

The viscosity of the spinning solution is preferably 1 cps to 50,000 cps and more preferably about 100 cps to 20,000 cps. By controlling the viscosity of the spinning solution and the size of the spinning nozzle, a nanofiber having an arbitrary fiber diameter can be obtained.

The solvent which can be used for making the spinning solution includes, for example, aprotic polar solvents such as N-methyl-2-pyrrolidone, N,N-dimethylacetamide, N,N-dimethylformamide, N-methylcaprolactam, N,N-dimethylimidazolidine, dimethylsulfoxide, tetramethylurea and pyridine; nonpolar solvents such as toluene, xylene, hexane, cyclohexane and heptane; other solvents such as acetone, methyl ethyl ketone, cyclopentanone, cyclohexanone, methyl acetate, ethyl acetate, caprolactone, butyrolactone, valerolactone, tetrahydrofuran, ethylene glycol, propylene glycol, diglyme, triglyme, propylene glycol monomethyl ether monoacetate, dioxane and trioxane. These may be used either alone or as a mixed solvent thereof.

In view of solubility and volatility of the heat curable polyamide resin composition for fiber of the present invention, N-methyl-2-pyrrolidone, N,N-dimethylacetamide, N,N-dimethylformamide (DMF) and the like are preferable, and in view of volatility thereof, N,N-dimethylformamide (DMF) is most preferable.

The solid content concentration in the spinning solution is preferably usually 15 to 40% by mass relative to the whole spinning solution.

The nonwoven fabric of the present invention can be obtained by peeling a deposit of a nanofiber obtained by electrospinning off a substrate and by heat treatment at 150 to 250° C. for 10 minutes to 2 hours and preferably at about 200° C. for 30 minutes to 1 hour, under ordinary pressure, under increased pressure or after stretching. The contact parts of the nanofibers are strongly bonded in curing reaction by heating to obtain a nonwoven fabric being excellent in heat resistance and chemical resistance and having high strength.

The thickness of the nonwoven fabric can be appropriately controlled by the amount to be accumulated or by piling nanofiber deposits having a suitable thickness. It is usually about 30 nm to 1 mm and preferably usually about 100 nm to 300 μm.

The nonwoven fabric of the present invention obtained in such a manner can be used for application to, for example, heat resistant bag filters, secondary battery separators, secondary battery electrodes, heat insulating materials, filter cloth and sound absorbing materials and the like, in light of the properties it has.

For example, the heat resistant bag filter can be used as a bag filter for general garbage incinerators and industrial waste incinerators.

In addition, the secondary battery separator can be used as a separator for lithium ion secondary batteries.

Further, the secondary battery electrode can be used as a binder for forming secondary battery electrodes by using a deposit of the heat curable nanofiber before heat-curing. Furthermore, a conductive nonwoven fabric obtained by dispersing a powder electrode material in the spinning solution of the present invention and mixing, by electrospinning the mixture and by heat-curing the deposit can be also used as a secondary battery electrode.

In addition, the heat insulating material can be used as a backup material and a combustion gas seal for heat resisting bricks.

Further, the filter cloth can be used as a filter cloth or the like for microfilters by appropriately controlling the thickness and the like of the nonwoven fabric and by controlling the size of the nonwoven fabric pore. By using said filter cloth, a solid content in a fluid such as liquid or gas can be separated.

Furthermore, the sound absorbing material can be used as a sound absorbing material for sound insulation reinforcement on wall, sound absorption layers in wall, and the like.

### EXAMPLES

Hereinafter, the present invention will be more specifically explained with reference to the following examples, but the present invention is not limited to these examples.

### Synthesis Example 1

To a flask equipped with a thermometer, a cooling tube and a stirrer, which is purged with nitrogen gas, 1.8 g of 5-hydroxyisophthalic acid, 81.3 g of isophthalic acid, 102 g of 3,4′-diaminodiphenyl ether, 3.4 g of lithium chloride, 344 g of N-methylpyrrolidone and 115.7 g of pyridine were added and dissolved by stirring followed by addition of 251 g of triphenyl phosphite, and the mixture was reacted at 90° C. for 8 hours. As a result, a reaction liquid containing a) a phenolic hydroxy group-containing polyamide resin represented by the following formula (6):

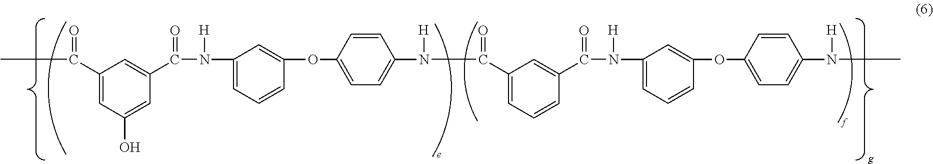

was obtained. This reaction liquid was cooled to room temperature and then put into 500 g of methanol to precipitate a resin, which is filtered and washed with 500 g of methanol and then further purified under reflux of methanol. Subsequently, the mixture was cooled to room temperature followed by filtration, and the filtrate was dried to obtain a resin powder. The obtained amount is 160 g and the yield is 96%.

In this regard, e, f and g in the above-described formula (6) have the same meanings as those of x, y, and z in the above formula (A), and are each an average repeating number (average degree of polymerization) of a segment. The resin obtained as described above had an e/(e+f) value of 0.022 as calculated from the charged amount of the raw material and a weight average molecular weight of 80,000 as calculated on the basis of polystyrene from the measurement result by gel permeation chromatography.

In 20.0 ml of N,N-dimethylacetamide, 0.100 g of this resin powder was dissolved, and the inherent viscosity as measured at 30° C. using an Ostwald viscometer was 0.60 dl/g. The calculated value of the active hydrogen equivalent for the epoxy group was 3300 g/eq (the hydroxy group equivalent was 17,000 g/eq). In this regard, the active hydrogen equivalent for the epoxy group is an equivalent number of hydrogen atoms which can be reacted with the epoxy group.

### Examples 1 to 4

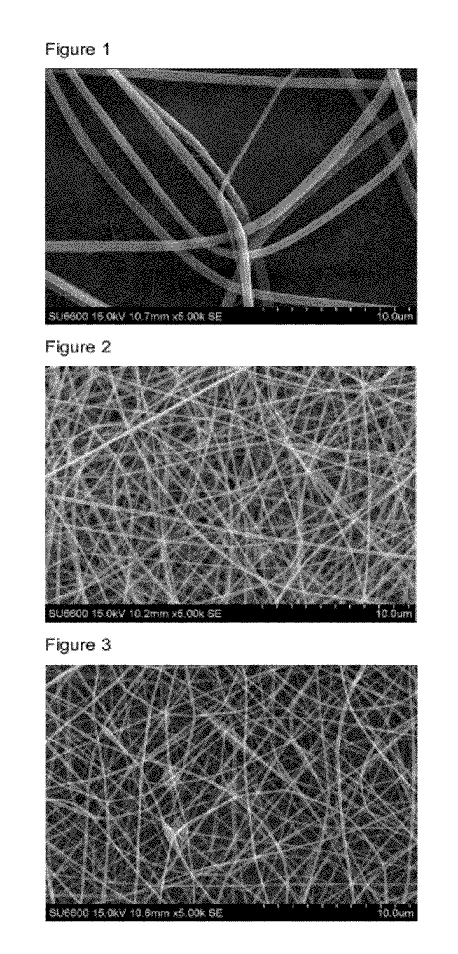

The polyamide resin obtained in Synthesis Example 1, epoxy resin NC-3000 (manufactured by Nippon Kayaku Co., Ltd., epoxy equivalent: 275 g/eq, softening point: 58° C., and average repeating number m of a segment in the formula (5): about 2.5) represented by the above formula (5) as an epoxy resin, GPH-65 (manufactured by Nippon Kayaku Co., Ltd., hydroxy group equivalent: 170 g/eq, and softening point: 65° C.) as a curing agent, 2-methylimidazole (2MZ) as a curing accelerator and N,N-dimethylformamide (DMF) as a solvent were mixed in the parts by mass shown in the table 1 to prepare a solution (spinning solution) of a heat curable polyamide resin composition for fiber of the present invention. The obtained resin composition was filled into a syringe with a metal needle having an internal diameter of 0.35 mm, and an aluminum foil substrate was set on a 100 mm sq. SUS plate (collector) at 200 mm directly below the needle tip. After that, the voltage shown in the table 1 was applied between the metal needle and the SUS plate, and a nanofiber of the present invention having a fiber length of 25 μm or more was obtained by electrospinning. The fiber diameter is shown in the table 1 and the electron microscope photograph of the obtained nanofiber is shown in the FIGS. 1 to 4.

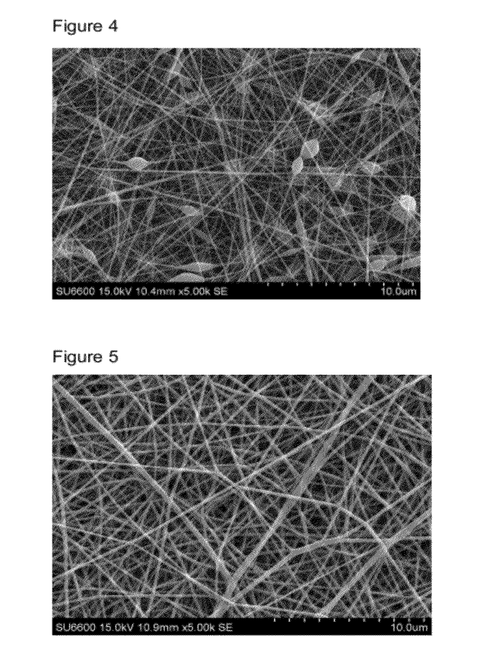

TABLE 1

| | Example 1 | Example 2 | Example 3 | Example 4 |
|---|---|---|---|---|
| Polyamide resin | 85 | 85 | 85 | 85 |
| NC-3000 | 10 | 10 | 10 | 10 |
| GPH-65 | 5 | 5 | 5 | 5 |
| 2 MZ | 0.2 | 0.2 | 0.2 | 0.2 |
| DMF | 170 | 300 | 426 | 426 |
| Solid content | 37% | 25% | 19% | 19% |
| concentration | | | | |
| Applied voltage | 12 kV | 13 kV | 13 kV | 20 kV |
| Average fiber diameter | 800 nm | 150 nm | 120 nm | 80 nm |
| Electron | FIG. 1 | FIG. 2 | FIG. 3 | FIG. 4 |
| microscope photo. | | | | |

### Example 5

A deposit of the heat curable polyamide resin composition nanofiber obtained in the example 2 was subjected to heat treatment at 200° C. for 1 hour to obtain a nonwoven fabric of the present invention. The obtained nonwoven fabric was immersed in N,N-dimethylformamide for 30 minutes to confirm that it was insoluble (FIG. 5).

### Comparative Example 1

Only the polyamide resin obtained in Synthesis Example 1 was dissolved in DMF to prepare a 21% by mass solution, the solution was filled into a syringe with a metal needle having an internal diameter of 0.35 mm, an aluminum foil substrate was placed on a 100 mm sq. SUS plate at 200 mm directly below the needle tip, a 13 kV voltage was applied between the metal needle and the SUS plate, and a deposit of a polyamide resin nanofiber having a fiber diameter of 150 nm was obtained by electrospinning. The present nanofiber deposit was subjected to heat treatment at 200° C. for 1 hour, and when the resulting nonwoven fabric was immersed in N,N-dimethylformamide for 30 minutes, it was dissolved.

### Example 6

Each deposit of the heat curable polyamide resin composition nanofibers obtained in Examples 1 to 4 was cut into 20 cm sq. pieces, two pieces thereof were overlapped each other with a width of 1 mm and subjected to heat treatment at 200° C. for 1 hour using hot plate press to obtain each nonwoven fabric sample of the present invention in which the two pieces were adhered with a width of 1 mm. In order to measure the adhesive strength of the adhered part of each obtained nonwoven fabric sample, it was stretched from both ends until it was broken to measure its break strength. As a result, in each sample, there is no peeling at the adhered part and a part other than the adhered part was broken. The measurement results of break strength are shown in the table 2.

TABLE 2

| | Example 1 | Example 2 | Example 3 | Example 4 |
|---|---|---|---|---|
| Break strength | 115 Mpa | 122 Mpa | 120 Mpa | 118 Mpa |

From the results in the above table, it is found that in the nonwoven fabrics obtained according to the present invention, fibers are fixed to each other without using an adhesive, so that very strong nonwoven fabrics can be obtained.

### Comparative Example 2

The polyamide resin nanofiber deposit obtained in Comparative Example 1 was treated in the same manner as in Example 6 to obtain a nonwoven fabric. The adhesive strength of the obtained nonwoven fabric was tried to measure in the same manner as described above, but it could not be measured because two pieces of the nonwoven fabric were not adhered and the two pieces were separated before subjecting to a measuring machine. In addition, the two pieces of the nonwoven fabric obtained as described above also got loose during treatment because the nanofibers were not fixed to each other.

### INDUSTRIAL APPLICABILITY

The fiber comprising the heat curable polyamide resin composition of the present invention can be made into a nonwoven fabric by heat-curing a deposit thereof, and fibers in said nonwoven fabric are directly bonded and cured with each other at a contact part, so said nonwoven fabric has such characteristics that its chemical resistance and mechanical strength are more excellent than those of conventional nonwoven fabrics. Particularly in the present invention, a nonwoven fabric comprising nanofibers can be easily manufactured, and said nonwoven fabric has the above-described characteristics and therefore can be utilized for heat resistant bag filters, secondary battery separators, heat insulating materials, various filters, sound absorbing materials and the like.

1. A heat curable fiber comprising a heat curable polyamide resin composition containing a) a phenolic hydroxy group-containing polyamide resin and b) an epoxy resin having two or more epoxy groups in one molecule.

2. The heat curable fiber according to claim 1, wherein a) the phenolic hydroxy group-containing polyamide resin is a random copolymer aromatic polyamide resin having a repeating structure represented by the following formula (A): 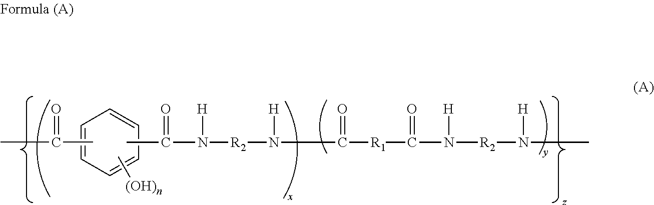
wherein R₁ and R₂ each represents a divalent aromatic group and may be the same or different from each other; n is an average number of substituents and represents a positive number of 1 to 4; and x, y and z are each an average degree of polymerization, x represents a positive number of 1 to 10, y represents a positive number of 0 to 20 and z represents a positive number of 1 to 50, respectively.

3. The heat curable fiber according to claim 1 or 2, which is a nanofiber having a fiber diameter of 10 to 1000 nm.

4. The heat curable fiber according to claim 3, which is produced by electrospinning method.

5. A nonwoven fabric, wherein a deposit of the heat curable fiber according to claim 3 is heat-cured.

6. A heat resistant bag filter, wherein the nonwoven fabric according to claim 5 is used.

7. A secondary battery separator, wherein the nonwoven fabric according to claim 5 is used.

8. A secondary battery electrode, wherein the nonwoven fabric according to claim 5 is used.

9. A heat insulating material, wherein the nonwoven fabric according to claim 5 is used.

10. A filter cloth, wherein the nonwoven fabric according to claim 5 is used.

11. A sound absorbing material, wherein the nonwoven fabric according to claim 5 is used.

12. A method for producing a heat curable fiber, characterized in that while applying a voltage between a spinning nozzle of a container for electrospinning and a collector; a spinning solution is spun from the spinning nozzle; and thus obtained nanofiber according to claim 3 is collected on the collector; the container is filled with a solution including a heat curable polyamide resin composition containing a) a phenolic hydroxy group-containing polyamide resin and b) an epoxy resin having two or more epoxy groups in one molecule and the.

13. A method for manufacturing a nonwoven fabric with nanofibers fixed to each other, wherein a deposit of the nanofiber according to claim 3 is obtained by electrospinning and the deposit is heat-cured.

14. Use of a heat curable polyamide resin composition containing a) a phenolic hydroxy group-containing polyamide resin and b) an epoxy resin having two or more epoxy groups in one molecule, for producing a fiber.

15. A heat curable polyamide resin composition for fiber, which contains a) a phenolic hydroxy group-containing polyamide resin and b) an epoxy resin having two or more epoxy groups in one molecule.

16. The heat curable polyamide resin composition for fiber according to claim 15, wherein a) the phenolic hydroxy group-containing polyamide resin is a random copolymer aromatic polyamide resin having a repeating structure represented by the following formula (A): 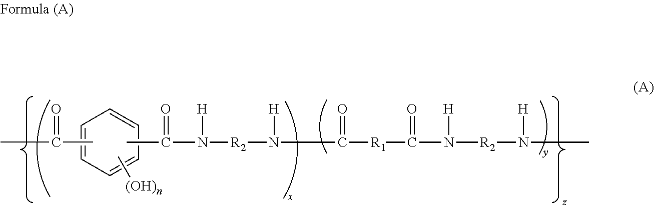
wherein, R₁ and R₂ each represents a divalent aromatic group and may be the same or different from each other; n is an average number of substituents and represents a positive number of 1 to 4; and x, y and z are each an average degree of polymerization, x represents a positive number of 1 to 10, y represents a positive number of 0 to 20 and z represents a positive number of 1 to 50, respectively.
